(19) United States
(12) Patent Application Publication
(10) Pub. No.: US 2007/0285359 A1
(43) Pub. Date: Dec. 13, 2007

(54) DISPLAY APPARATUS

(76) Inventor: Shinya Ono, Yokohama-shi (JP)

Correspondence Address: Frank Pincelli;Patent Legal Staff, Eastman Kodak Company, 343 State Street, Rochester, NY, 14650-2201, US

(21) Appl. No.: 11/743,179

(22) Filed: May 2, 2007

(30) Foreign Application Priority Data
May 16, 2006 (JP) 2006-137080

(51) Int. Cl. G09G 3/30

(52) U.S. Cl. 345/76

(57) ABSTRACT

A display including a plurality of pixels in matrix, wherein each pixel includes first and second power source lines; a switching device for controlling writing of a signal voltage supplied via a signal line; a capacitor for storing the signal voltage supplied via the switching device; an n-type driver device having a gate electrode and first and second electrodes for providing current corresponding to the signal voltage stored by the capacitor; a light emitting device having an anode and a cathode for emitting light in response to the current. The display makes use of storing a voltage related to the threshold voltage of the driving device during a second portion of the operating time.

### CROSS-REFERENCE TO RELATED APPLICATION

This application claims priority of Japanese Patent Application No. 2006-137080 filed May 16, 2006 which is incorporated herein by reference in its entirety.

### FIELD OF THE INVENTION

The present invention relates to an active matrix display which drives a light emitting device using a driver device for each pixel.

### BACKGROUND OF THE INVENTION

Using organic electroluminescence (EL) devices that emit light by themselves, organic EL displays require no backlight needed for liquid crystal displays and are thus best suited for slimming down such apparatus. In addition, since there are no limitations to viewing angle, the organic EL displays have been expected to be practically used as the next-generation display. In the organic EL device used in an organic EL display, the brightness of light to be emitted is controlled by the current value flowing therein, and thus there is a difference from liquid crystal displays and the like in which displaying is controlled by voltage.

FIG. 7 illustrates a pixel circuit in an active matrix organic EL display known in the art. This pixel circuit includes: a light emitting device 104 having the cathode thereof connected to a negative electric power source line 108; a driver device 102 having the source electrode thereof connected to the anode of the light emitting device 104 and the drain electrode thereof connected to a positive electric power source line 107; a capacitor 103 connected between the gate electrode and the source electrode of the driver device 102; and a switching device 101 having the source electrode or drain electrode thereof connected to the gate electrode of the driver device 102 and the drain electrode or source electrode thereof connected to a signal line 105 and the gate electrode thereof connected to a scanning line 106. Here, the switching device 101 and the driver device 102 are a thin-film transistor (TFT).

The operation of the above pixel circuit will be described below. First, assume that a voltage higher than a threshold voltage of the driver device 102 has been retained in a stable manner between the gate and source electrodes of the driver device 102 by the capacitor 103. Thus the driver device 102 is on.

In this state, the negative electric power source line 108 is changed to a level higher than a potential GND of the positive electric power source line 107. With the driver device 102 kept in an on state, the potential of the anode electrode of the light emitting device 104 becomes identical to potential GND of the positive electric power source line 107 and thus a reverse bias voltage is applied to the light emitting device 104.

Subsequently, the scanning line 106 is changed to a high level to change the switching device 101 to an on state, and then a potential of the signal line 105 is applied to the gate electrode of the driver device 102. The potential of this signal line is identical to potential GND. Accordingly, the potential of the anode electrode of the light emitting device 104 becomes lower than the gate potential GND of the driver device 102 according to the capacitance ratio between a capacitance component of the light emitting device 104 and the capacitor 103 and thus the driver device 102 turns off.

Subsequently, when the negative electric power source line 108 is lowered to the same potential GND as the positive electric power source line 107, the source of the driver device 102 is lowered according to the voltage drop of the negative electric power source line, but the gate potential of the driver device 102 is GND, and thus the driver device 102 turns on. Accordingly, a current is supplied from the positive electric power source line 107 through the driver device 102 to the anode electrode of the light emitting device 104, and thus the potential of the anode electrode of the light emitting device 104 continues to rise gradually until the potential difference between the gate electrode of the driver device 102 and the anode electrode of the light emitting device 104 becomes identical to the threshold voltage of the driver device 102.

Thereafter, when the potential of the scanning line 106 is changed to a low level, the threshold voltage of the driver device 102 can be retained at the source electrode of the driver device 102 by the capacitor 103 and the capacitance component of the light emitting device 104.

The step of causing the capacitor 103 to retain the threshold voltage Vt of the driver device 102 in this manner is hereinafter referred to as “threshold voltage detection”.

Subsequently, while a data voltage Vdata is supplied to the signal line 105, when the scanning line 106 is changed to a high level to apply the data voltage Vdata of the signal line 105 to the gate electrode of the driver device 102, the source electrode of the driver device 102 changes at that moment according to the capacitance ratio between a capacitance value Cs of the capacitor 103 and a capacitance value Coled and thus the gate-source electrode potential of the driver device 102 is expressed as follows.

Vgs={Cs/(Cs+Coled)}·Vdata+Vt (formula 1)

This potential difference Vgs is retained in a stable manner by the capacitor 103. This step of adding a data voltage is hereinafter referred to as “writing”.

Also, when the negative electric power source line 108 is lowered so that the potential difference between the positive electric power source line 107 and the negative electric power source line 108 becomes sufficiently larger than the threshold voltage of the light emitting device 104, then the driver device 102 controls current flowing in the light emitting device 104 according to the voltage retained by the capacitor 103 in the above described step, and the light emitting device 104 continues to emit light with a brightness corresponding to that current value.

As described above, in the pixel circuit illustrated in FIG. 7, once writing of brightness information is performed, the light emitting device 104 continues to emit light with a given brightness until the writing state is canceled (see U.S. Published Patent Application 2004/0174349)

However, when a data voltage is applied via the switching device 101 in the above described writing step, the driver device 102 turns on at that moment, as is evident from formula 1. Consequently, the threshold voltage of the driver device 102 retained at the node between the capacitor 103 and the light emitting device 104 is more likely to disappear and thus it is difficult to superimpose the threshold voltage information correctly as expressed by formula 1. Particularly, the degree of disappearance of threshold voltage becomes large with increasing data voltage Vdata and with increasing write time period.

### SUMMARY OF THE INVENTION

According to the present invention, there is provided an active matrix display comprising: a light emitting device for emitting light in response to a current supplied thereto; a data writing unit for writing a signal voltage corresponding to a brightness of light to be emitted by the light emitting device; a current value controller for controlling a value of current supplied to the light emitting device according to the signal voltage written by the data writing unit; and a power source line for supplying a current to the light emitting device, wherein the data writing unit includes: a signal line for supplying a potential corresponding to the brightness of light to be emitted; a signal line drive circuit for supplying a signal voltage corresponding to the brightness of light to be emitted to the signal line; a switching device for controlling writing of the signal voltage supplied via the signal line; a scanning line for controlling the switching device; and a scanning line drive circuit for controlling the scanning line, and the current value controller includes: a driver device for controlling a value of current flowing in the light emitting device according to the signal voltage written by the data writing unit; and a capacitor connected to a gate electrode of the driver device, for retaining, with respect to the gate electrode, at least the written signal voltage and a drive threshold voltage of the driver device during a light emitting period of the light emitting device, and the drive threshold voltage is a drive threshold voltage between the gate electrode and a drain electrode of the driver device during light emitting.

Preferably, in the signal line, a period during which a drive threshold detection voltage applied to detect the drive threshold voltage is supplied, is arranged between periods during which the signal voltage corresponding to the brightness of light to be emitted by the light emitting device is supplied.

Further preferably, the switching device is preferably in a conducting state during detection of the drive threshold voltage.

Further preferably, a first electrode of the capacitor is connected to the gate electrode of the driver device, and a second electrode of the capacitor is connected to the drain electrode of the driver device.

Further preferably, a power source line control unit is provided which controls a voltage of the power source line to perform switching between a conducting state and a non-conducting state of the light emitting device.

Further preferably, no switching device for short circuit is arranged between the gate electrode, and the drain electrode or source electrode of the driver device.

According to the present invention, with respect to the gate electrode of the driver device, at least a signal voltage and a drive threshold voltage of the driver device are retained by the capacitor. Accordingly, when writing of a signal voltage is performed, the pixel data signal can be superimposed on the threshold voltage of the driver device retained by the capacitor without losing the threshold voltage, and it is also possible to set the threshold voltage with the switching device kept in a conducting state.

### BRIEF DESCRIPTION OF THE DRAWINGS

FIG. 1 is a view illustrating a construction an embodiment of the present invention;

FIG. 2 is a timing chart of the embodiment shown in FIG. 1;

FIG. 3A is a view illustrating an initial state of the threshold voltage detection step (1) of FIG. 2;

FIG. 3B is a view illustrating a final state of the threshold voltage detection step (1) of FIG. 2;

FIG. 3C is a view illustrating a state of the writing step (2) of FIG. 2;

FIG. 3D is a view illustrating a state of the light emitting step (3) of FIG. 2;

FIG. 4 is a view illustrating another embodiment of the present invention;

FIG. 5 is a timing chart of the embodiment shown in FIG. 4;

FIG. 6A is a view illustrating an initial state of the threshold voltage detection step (1) of FIG. 5;

FIG. 6B is a view illustrating a final state of the threshold voltage detection step (1) of FIG. 5;

FIG. 6C is a view illustrating a state of the writing step (2) of FIG. 5;

FIG. 6D is a view illustrating a state of the light emitting step (3) of FIG. 5;

FIG. 7 is a view illustrating a configuration of a prior art pixel circuit;

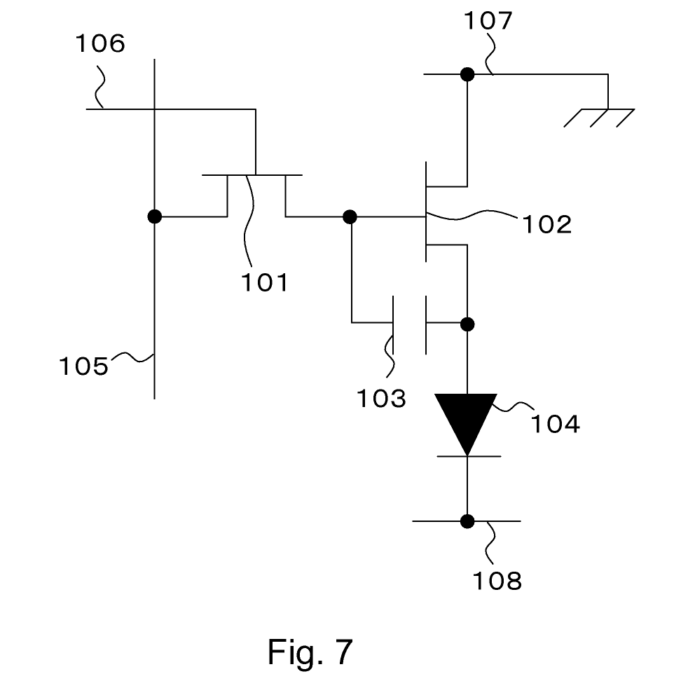

FIG. 8 is a view illustrating an embodiment of the present invention;

FIG. 9 is a timing chart for FIG. 8; and

FIG. 10 is a view illustrating the state of voltage at each unit.

### DESCRIPTION OF THE PREFERRED EMBODIMENTS

Specific aspects of the present invention will be described below with reference to the drawings. It is noted that the scope of the invention is not limited to the illustrated examples.

### First Basic Configuration

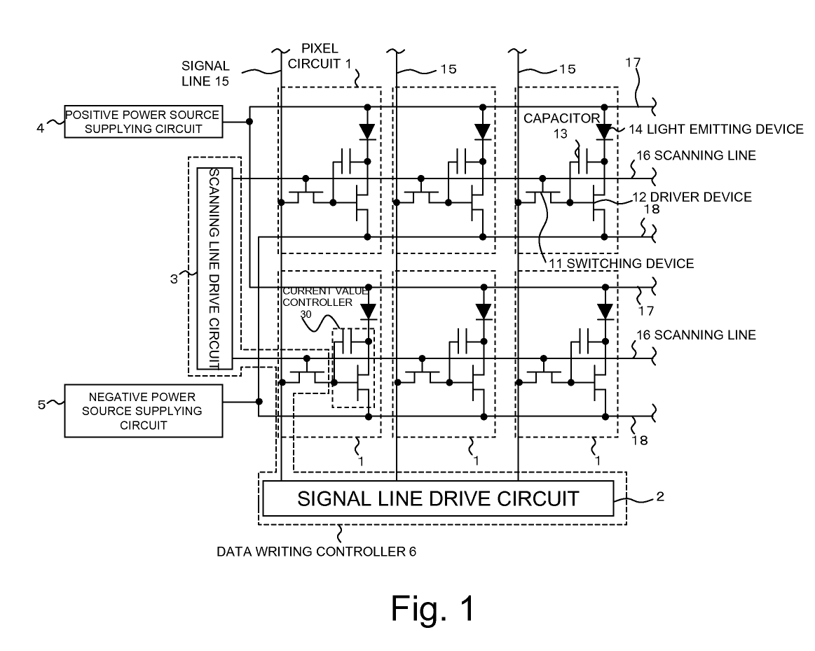

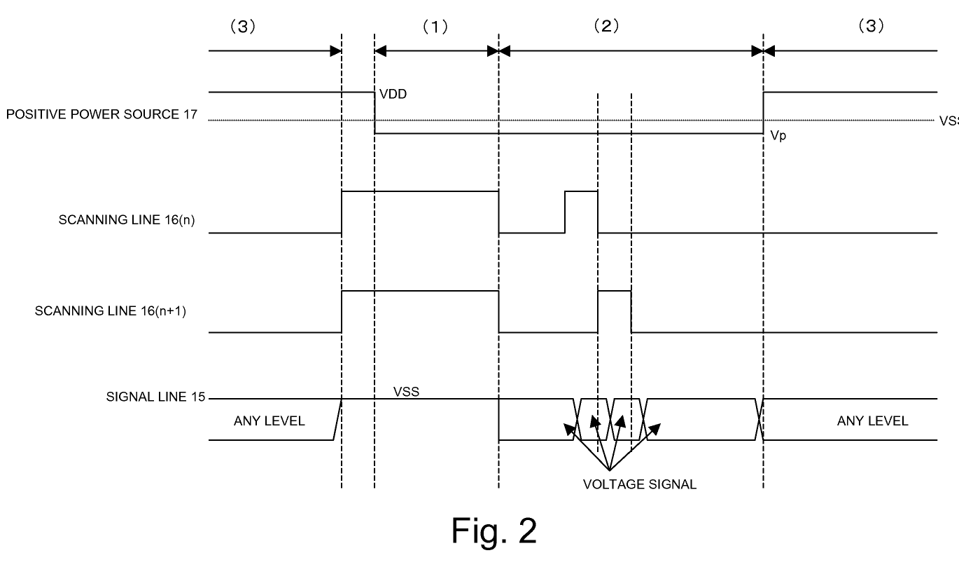

FIG. 1 illustrates a circuit configuration for a display according to the present invention; and FIG. 2 illustrates a timing chart thereof.

The display is constituted of many pixel circuits 1 arranged in a matrix shape, and arranged in each pixel are an organic EL light emitting device (OLED), being a light emitting device, and a circuit for controlling light emission thereof.

A positive electrical power source supplying circuit 4 outputs a positive electrical power source voltage VDD, but performs switching at a predetermined timing to output a voltage Vp lower than a negative electrical power source voltage VSS to be supplied to each pixel. A signal line drive circuit 2 supplies a signal voltage Vdata to be displayed by each pixel to each signal line 15 arranged for each vertical line. A scanning line drive circuit 3 supplies a signal for driving a scanning line 16 arranged for each horizontal line. A negative electrical power source supplying circuit 5 supplies a negative electrical power source voltage VSS for causing a current to flow in the light emitting device.

In each pixel circuit, a positive electrical power source line 17 is connected to the positive electrical power source supplying circuit 4, and this positive electrical power source line 17 is connected to the anode electrode of a light emitting device 14 of each pixel circuit. The drain electrode of an n-type driver device 12 is connected to the cathode electrode of the light emitting device 14, and the source electrode of the driver device 12 is connected to a negative electrical power source line 18. A capacitor 13 is connected between the gate electrode and drain electrode of the driver device 12 is.

The source electrode of a switching device 11 is connected to the gate electrode of the driver device 12, and the drain electrode of the switching device 11 is connected to the signal line 15. The scanning line 16 is connected to the gate electrode of the switching device 11. In this embodiment, the signal line drive circuit 2, scanning line drive circuit 3 and switching device 11 constitute a data writing controller 6.

Here, an n-type TFT is used as the switching device 11, but a p-type TFT may also be used. When the type of TFT is changed, the polarity of a signal supplied to the scanning line 16 must be reversed. The driver device 12 is an n-type TFT.

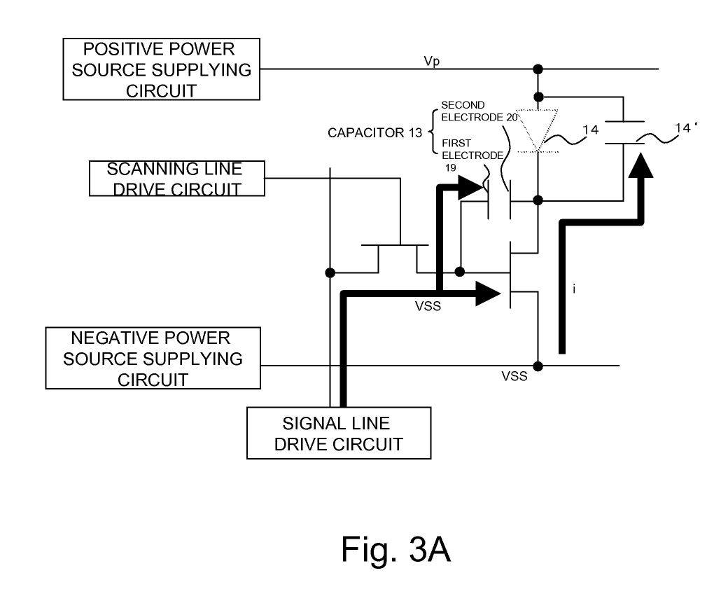

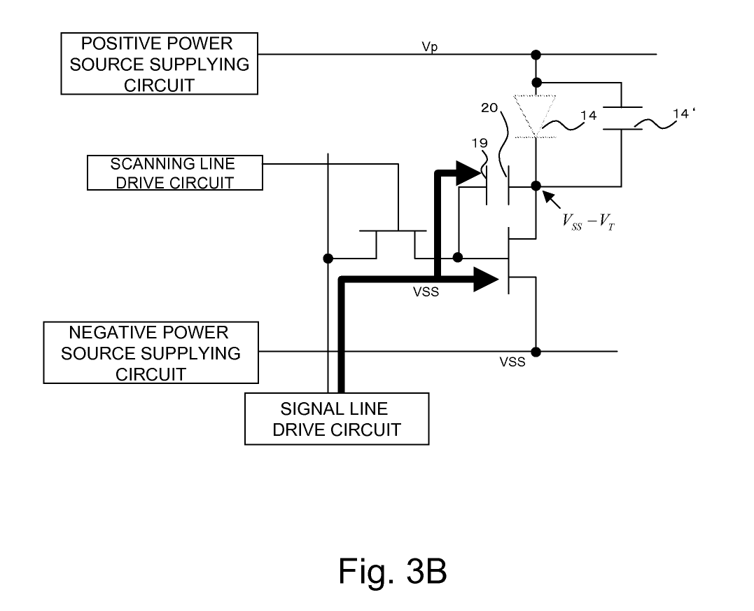

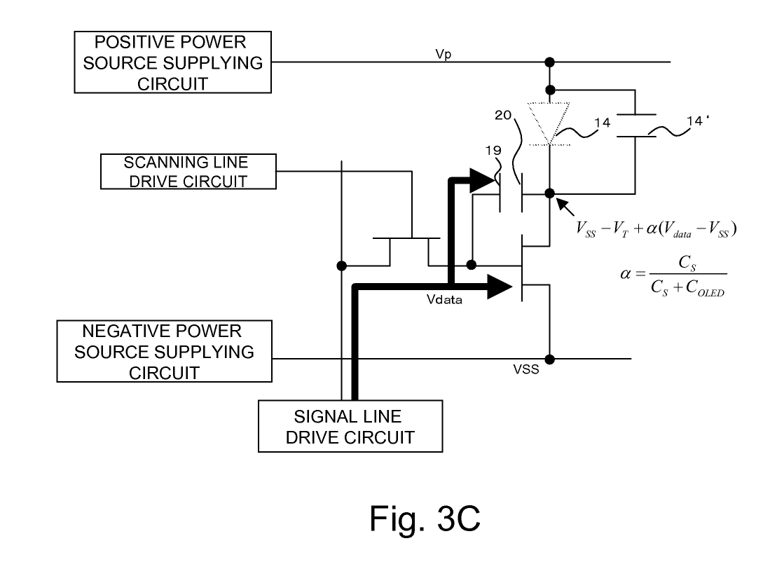

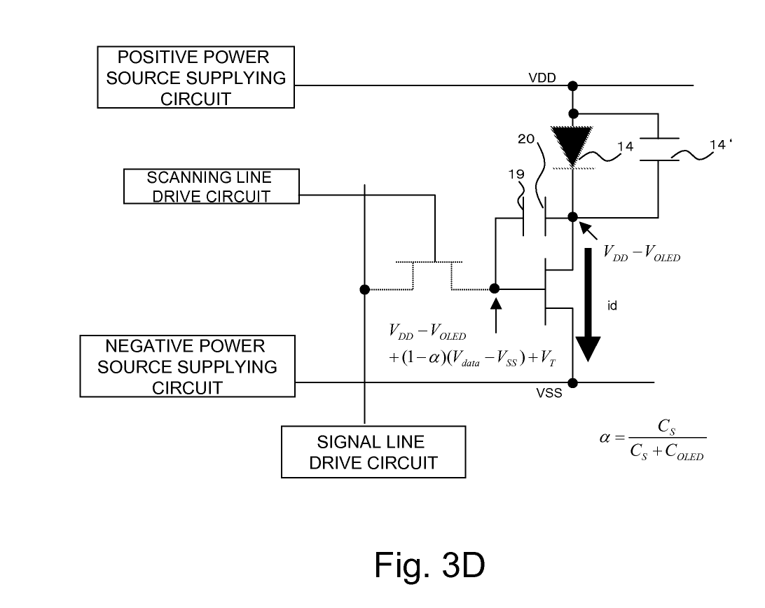

The operation of the above described pixel circuit will be described with reference to the timing chart of FIG. 2 and to FIG. 3.

First, assume that (Vdata+Vt) is retained by the capacitor 13 at the gate electrode of the driver device 12 in the previous frame period. Vdata is the brightness data corresponding to the amount of light to be emitted by the light emitting device 14 of a particular pixel, and Vt is a threshold voltage of the driver device 12 of the particular pixel.

In this state, when writing timing of the particular pixel (the particular horizontal line) is reached, the scanning line 16 is changed to a potential (in this instance, H level) which causes the switching device 11 to turn on. Also, the potential of the signal line 15 is changed to a potential identical to potential VSS of the negative electrical power source line 18 to turn off the driver device 12.

Subsequently, the potential of the positive electrical power source line 17 is changed to Vp lower than VSS as illustrated in FIG. 3A. If the voltage drop of the light emitting device 14 is Voled, when the potential of the positive electrical power source line 17 is VDD, the potential of the drain electrode of the driver device 12 will be VDD-Voled, and when the potential of the positive electrical power source line 17 changes from VDD to Vp, the difference therebetween is distributed to a capacitance component Coled of the light emitting device 14 and a capacitance component Cs of the capacitor 13. A first electrode 19 of the capacitor 13 is connected to the gate electrode of the driver device 12 and a second electrode 20 of the capacitor 13 is connected to the drain electrode of the driver device 12.

Consequently, at the moment the potential of the positive electrical power source line 17 changes to Vp, the potential of the drain electrode of the driver device 12 is VDD−Voled+{Coled/(Cs+Coled)}(Vp−VDD). Here, if the maximum value of the range of threshold voltage of the driver device 12 to be compensated is Vt (TFT) (>0), Vp is set such that

VSS−Vt(TFT)>=VDD−Voled×{Coled/(Cs+Coled)}(Vp−VDD) (formula 2)

That is, the setting is performed such that the drain voltage of the driver device 12 lower than a value obtained by subtracting Vt (TFT) from VSS being the gate and source voltage of the driver device 12.

Consequently, starting just after the positive electric power source line 17 changes to Vp, threshold voltage detection step (1) of the driver device 12 is started. Then, as illustrated in FIG. 3A, a current flows from the source of the driver device 12 to the drain thereof, and potential VSS−Vt occurs at the drain electrode of the driver device 12 (FIG. 3B). This threshold voltage detection step (1) is executed simultaneously at all the pixels.

Subsequently, the scanning line 16 is changed to a level (in this instance, L level) to turn off the switching device 11, entering step (2) for writing a pixel signal into each pixel. That is, after changing the potential of the signal line 15 to Vdata, the scanning line 16 is set again so as to turn on the switching device 11, and the gate potential of the driver device 12 is changed to Vdata (<VSS). Accordingly, the gate voltage of the driver device 12 changes from VSS to Vdata, and the amount of change thereof is distributed to capacitance Cs of the capacitor 13 and capacitance Coled of the light emitting device 14. As a result, the potential of the drain electrode of the driver device 12 changes from VSS−Vt to VSS−Vt+{Cs/(Cs+Coled)} (Vdata−VSS)(FIG. 3C).

Consequently, at this time, the capacitor 13 is charged by

Vdata−(VSS−Vt+{Cs/(Cs+Coled)}(Vdata−VSS)).

This writing step (2) is executed line-sequentially as illustrated in FIG. 2. In this case, data writing may be performed simultaneously with respect to one horizontal line, or may be performed point-sequentially.

Subsequently, the positive electrical power source line 17 is changed to VDD so that the voltage applied to the light emitting device 14 becomes sufficiently higher than the threshold voltage of the light emitting device 14. Accordingly, the drain voltage of the driver device 12 changes to VDD−Voled. Consequently, the gate voltage of the driver device 12 changes to a value obtained by adding

Vdata −(VSS−Vt+{Cs/(Cs+Coled)}(Vdata−VSS))=(1−{Cs/(Cs+Coled)})(Vdata−VSS)+Vt

(the charge voltage of the capacitor 13) to VDD−Voled.

Accordingly, at this time, the potential difference between the gate and source electrodes of the driver device 12 changes to

Vgs=VDD−Voled−VSS+(Vdata−VSS){Coled/(Cs+Coled)}+Vt (formula 3) (FIG. 3D)

Thus, current id flowing in the driver device 12 is expressed as follows.

$$\begin{matrix}id = ( β / 2 ) {( Vgs - Vt )}^{2} \\ = ( β / 2 ) ( VDD - Voled - VSS + \\ { ( Vdata - VSS ) \{ Coled / ( Cs + Coled ) \} )}^{2}\end{matrix} \qquad ( formula 4 )$$

This current id is supplied to the light emitting device 14. The current id is not dependent on Vt and thus the threshold voltage of the light emitting driver device 12 of the light emitting device 14 is compensated.

Particularly, according to the present basic configuration, a capacitor is arranged between the gate electrode and drain electrode of the driver device 12 used for causing the light emitting device 14 to emit light, to detect a threshold voltage between the gate electrode and drain electrode of the driver device 12 used for causing the light emitting device 14 to emit light. Then, a voltage lower than the potential supplied to the gate electrode of the driver device 12 at the time of the threshold voltage detection is applied as the pixel signal, whereby brightness data Vdata can be superimposed on the gate voltage of the driver device 12 in the signal writing step without losing threshold voltage Vt of the driver device 12 retained by the capacitor 13.

### Second Basic Configuration

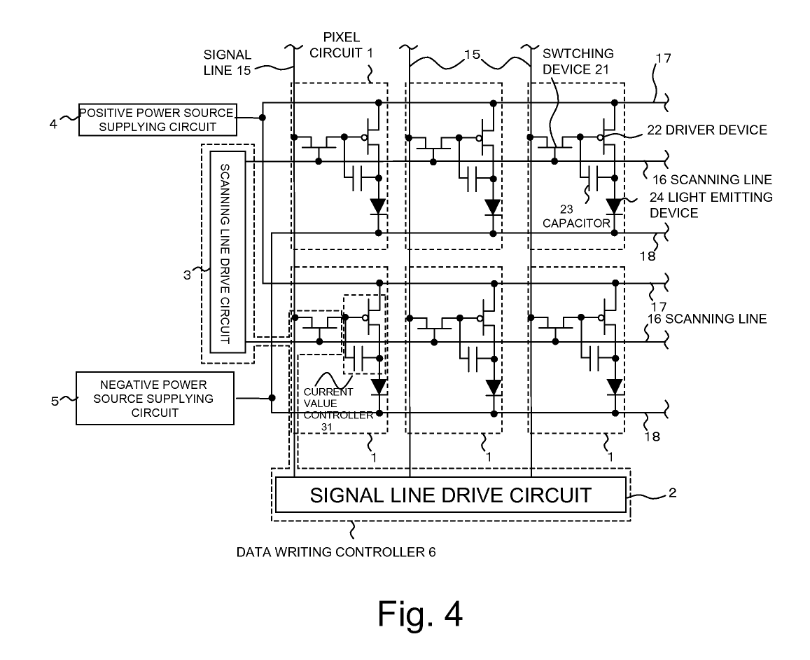

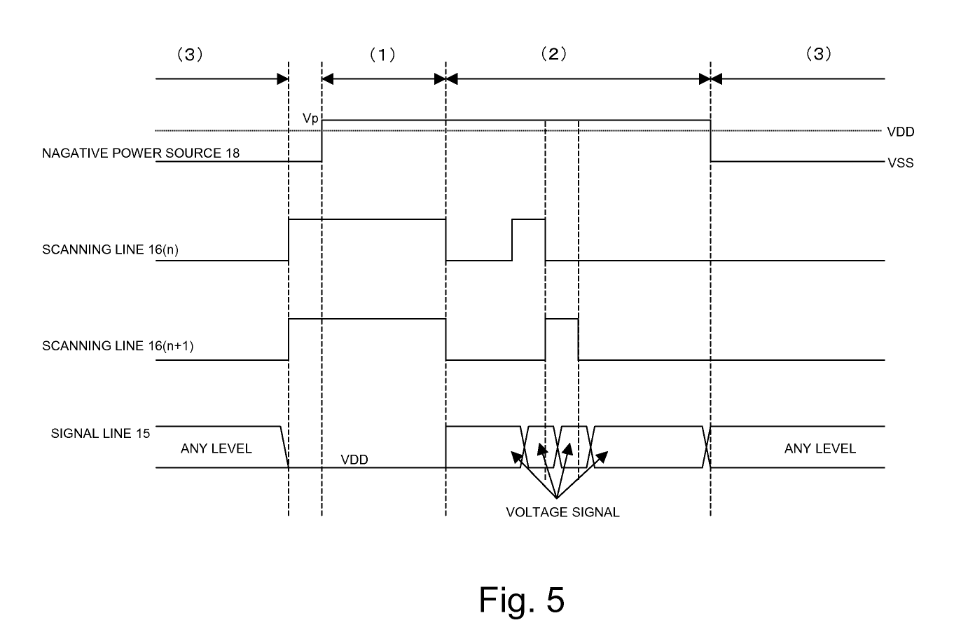

FIG. 4 illustrates a circuit configuration of another display to which the present invention is applied, and FIG. 5 illustrates a timing chart thereof.

The display includes: a light emitting device 24 having the cathode electrode thereof connected to a negative electrical power source line 18; a driver device 22 having the drain electrode thereof connected to the anode electrode of the light emitting device 24 and the source electrode thereof connected to a positive electrical power source line 17; a capacitor 23 connected between the gate electrode and drain electrode of the driver device 22 (A first electrode 29 of the capacitor 23 is connected to the gate electrode of the driver device 22 and a second electrode 30 of the capacitor 23 is connected to the drain electrode of the driver device 22.); and a switching device 21 having the source or drain electrode thereof connected to the gate electrode of the driver device 22, the drain or source electrode thereof connected to a signal line 15, and the gate electrode thereof connected to a scanning line 16. The switching device 21 is an n-type or p-type TFT, and the driver device 22 is a p-type TFT. In this embodiment, the switching device 21 and driver device 22 constitute a current value controller 31.

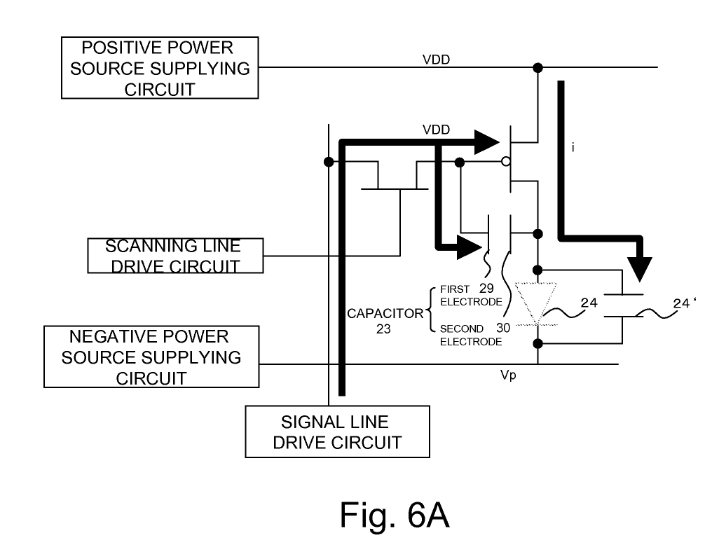

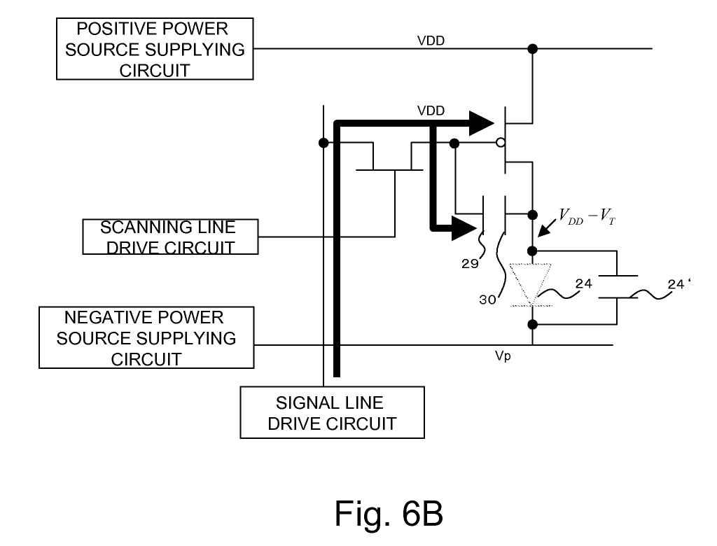

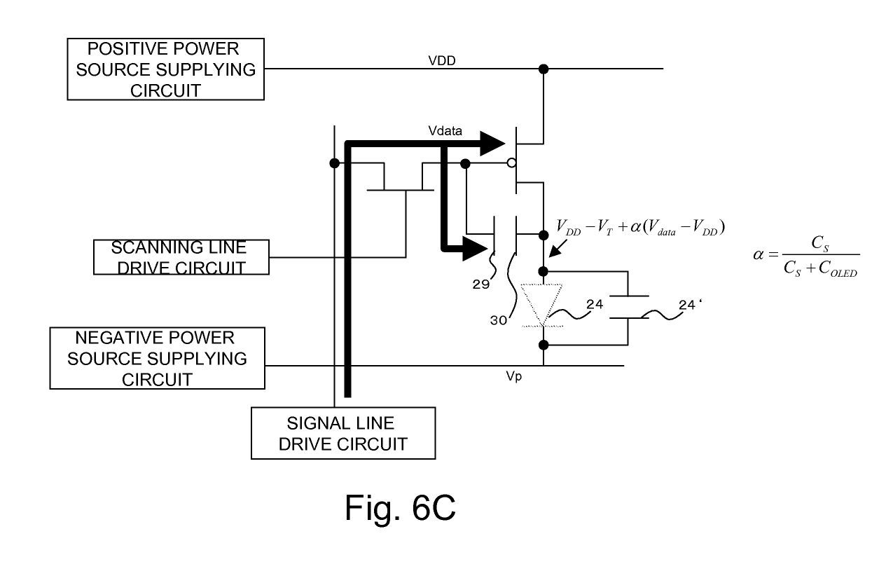

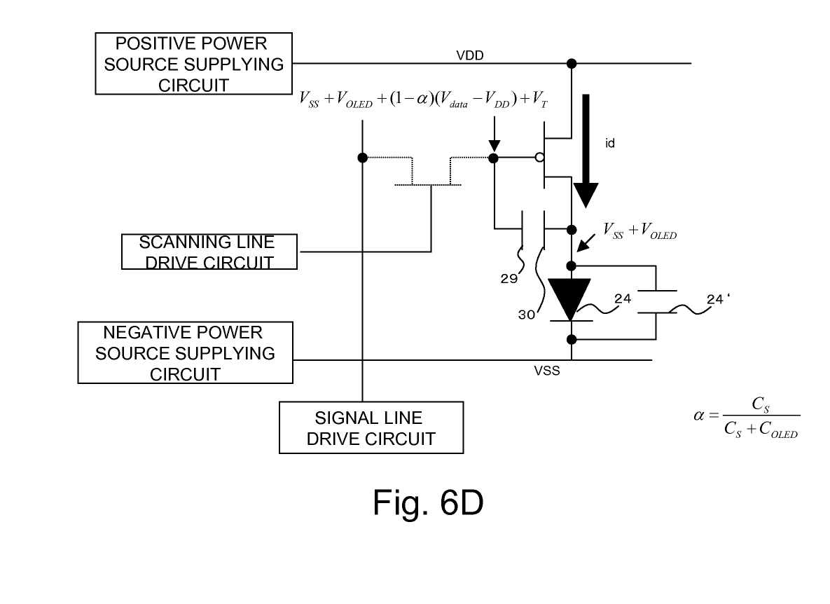

The operation of the above described pixel circuit will be described with reference to the timing chart of FIG. 5 and to FIG. 6. Assume that (Vdata−Vt) is retained by the capacitor 23 at the gate electrode of the driver device 22 in the previous frame period.

First the scanning line 16 is changed to a potential (in this instance, H level) which causes the switching device 21 to turn on. Also, the potential of the signal line is changed to a potential identical to a potential VDD of the positive electrical power source line 17 to turn off the driver device 22. Subsequently, the potential of the negative electrical power source line 18 is changed to Vp higher than VDD as illustrated in FIG. 6A. At the moment the potential of the negative electrical power source line 18 changes to Vp, the potential of the drain electrode of the driver device 22 is Voled+{Coled/(Cs+Coled)}(Vp-VSS). Here, if the range of threshold voltage of the driver device 22 to be compensated is Vt (TFT) (<0), Vp is set such that

VDD−Vt(TFT)<=Voled+{Coled/(Cs+Coled)}(Vp−VDD) (formula 5)

Starting just after the negative electric power source line 18 changes to Vp, threshold voltage detection step (1) of the driver device 22 is started. Then, potential VDD-Vt occurs at the drain electrode of the driver device 22 (FIG. 6B).

Subsequently, the scanning line 16 is changed to a level (in this instance, L level) to turn off the switching device 21, entering step (2) of writing a pixel signal into each pixel. That is, after changing the potential of the signal line 15 to Vdata, the scanning line 16 is set again to a level (in this instance, H level) so as to turn on the switching device 21, and the gate potential of the driver device 22 is changed to Vdata (>VDD). As a result, the potential of the drain electrode of the driver device 22 changes to VDD+{Cs/(Cs+Coled)} (Vdata−VDD)−Vt (FIG. 6C).

Subsequently, the negative electrical power source line 18 is changed to VSS so that the voltage applied to the light emitting device 24 becomes sufficiently lower than the threshold voltage of the light emitting device 24, and at the same time, the switching device 11 is turned off by the scanning line 16. Accordingly, the drain voltage of the driver device 22 changes to

### VSS+Voled and thus the gate voltage of the driver device 22 changes to Vss+Voled+(1−{Cs/(Cs+Coled)}(Vdata−VDD)+Vt.

Consequently, at this time, the potential difference between the source and gate electrodes of the driver device 22 is

Vsg=VDD−Voled−VSS+(Vdata−VDD) {Coled/(Cs+Coled)}−Vt (formula 6) (FIG. 6D).

Thus, the current flowing in the driver device 22 is expressed as follows.

id=(β/2)(Vsg+Vt)²=(β/2)(VDD−Voled−VSS+(Vdata−VDD){Coled/(Cs+Coled)})² (formula 7).

### Accordingly, the threshold voltage of the driver device 22 is compensated.

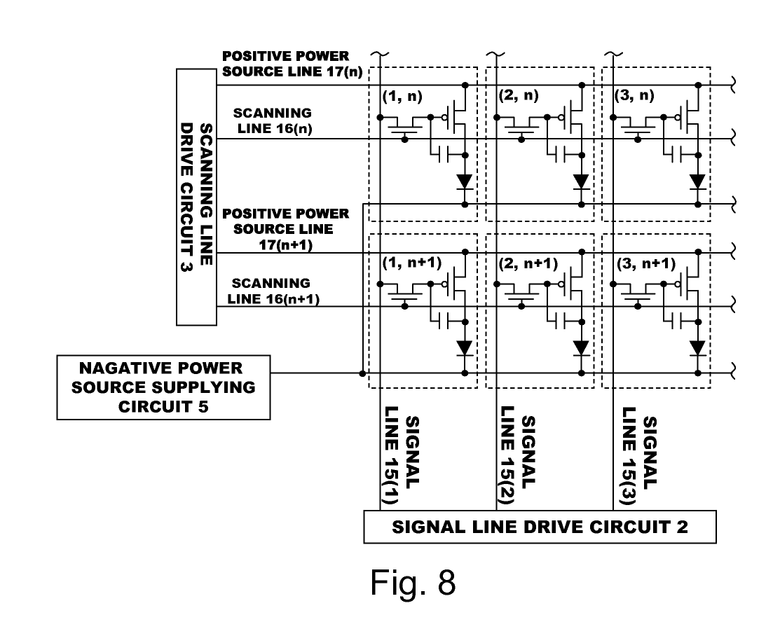

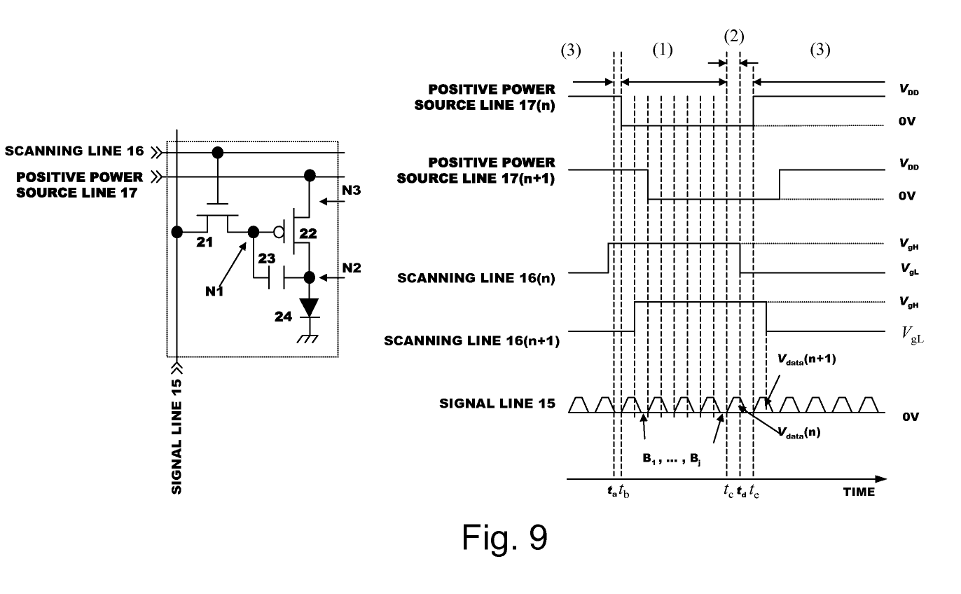

A display according to an embodiment of the present invention will now be described. FIG. 8 illustrates a circuit configuration thereof, and FIG. 9 illustrates a timing chart thereof. This circuit configuration is identical to that of FIG. 4 described above, but the configuration of FIG. 1 may be employed.

As described above, a signal supplied to each signal line 15 has inserted therein period B during which 0 (zero) V, being a threshold voltage detection reference voltage, is provided between periods of signal voltage (data) corresponding to the brightness of pixel on each line. More specifically, a threshold voltage detection reference voltage is inserted between n-th data and (n+1)th data.

The scanning line 16 (n) arranged for each line changes to H level V_{gH} starting just after the threshold voltage detection step is initiated, and changes to L level V_{gL} when the data writing is finished. Accordingly, the switching device 21 is in a conduction state during the threshold voltage detection step.

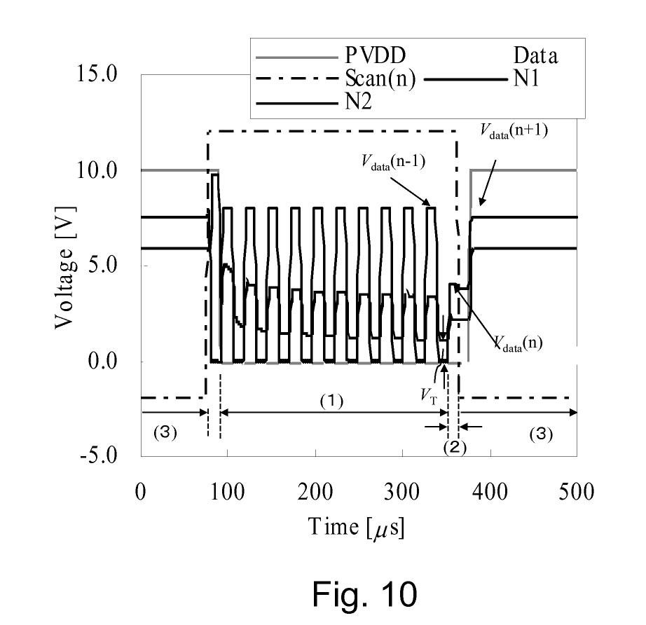

Similarly to the basic configuration described above, when the positive electrical power source line 17 is changed from VDD to 0 V, the threshold voltage detection step is initiated. During this threshold voltage detection step (period), data of each line and the threshold voltage detection reference voltage are alternately supplied to the signal line 15, and in data writing periods (period B₁, B₂, . . . , Bⱼ) corresponding to j-number of lines, a threshold voltage of the driver device 22 is detected. More specifically, as illustrated in FIG. 10, the drain electrode voltage V_{N2} is gradually set to a voltage lower than the gate electrode voltage V_{N1} by threshold voltage V_{T}.

Here, in this period, potential V_{N2} of the drain electrode of the driver device 22 connected to the light emitting device 24 is preferably lower than the threshold voltage of the light emitting device 24. The maximum value of the potential of the drain electrode of the driver device 22 is preferably lower than the threshold voltage of the light emitting device 24. The condition for this is expressed as formula 8. Here, N1, N2 and N3 denote the gate electrode, drain electrode and source electrode of the driver device 22, respectively.

V_{OLED,th}>V_{N2,max} (formula 7)

Under this condition, the threshold voltage of the driver device 22 is recorded on the drain electrode of the driver device 22.

In this example, when the voltage of the positive electrical power source line 17 is 0 V and in this state, the signal voltage of the signal line 16 changes to 0 V, then the gate voltage V_{N1} and source voltage V_{N3} of the driver device 22 change to 0 V, and on the other hand, voltage V_{N2} of the drain electrode N2 changes to a voltage of −V_{T} lower than 0 V by the threshold voltage V_{T}.

V_{N1}=0

V_{N2}=−V_{T}

V_{N3}=0

On the other hand, when formula 8 is not satisfied, the threshold voltage detection reference voltage will be set to V_{P}(<0), and the potential of the signal line 15 and the positive electrical power source line 17 shall be set to not 0 V but V_{P}.

Accordingly, instead of formula 8, when V_{P} is determined so as to satisfy

V_{OLED,th}>V_{data,max}−V_{T}+V_{P}

then threshold voltage V_{T} of the driver device 22 is recorded on the drain electrode N2 of the driver device 22.

Thereafter, when the switching device 21 is in an on state with the potential of the scanning line 16 being V_{gH} and the potential of the signal line 15 being V_{data}(n), the potential of the gate electrode, source electrode and drain electrode of the driver device 22 is expressed as follows.

V_{N1}=V_{data}>0

$${V}_{N 2} = \frac{{C}_{s}}{{C}_{s} + {C}_{OLED}} {V}_{data} - {V}_{T}$$

V_{N3}=0

Thus, on the capacitor 23, there is recorded the following;

$${V}_{N 1} - {V}_{N 2} = \frac{{C}_{OLED}}{{C}_{s} + {C}_{OLED}} {V}_{data} + {V}_{T}$$

### In this state, when the scanning line 16 (n) is changed to L level to turn off the switching device 21, this state is established.

Thereafter, the potential of the positive electrical power source line 17 is changed from the threshold voltage detection reference voltage to VDD, whereby a transition to the light emitting step is made. At this time, the following formula is provided;

$${V}_{N 1} = \frac{{C}_{OLED}}{{C}_{s} + {C}_{OLED}} {V}_{data} + {V}_{T} + {V}_{OLED}^{′}$$

V_{N2}=V′_{OLED}(≠V_{OLFD}^{o})

V_{N3}=V_{DD}

### Thus,

$$\begin{matrix}{V}_{sg} = {V}_{N 3} - {V}_{N 1} \\ = {V}_{DD} - \frac{{C}_{OLED}}{{C}_{s} + {C}_{OLED}} {V}_{data} - {V}_{T} - {V}_{OLED}^{′}\end{matrix}$$

### Finally, the following formula is provided;

$$\begin{matrix}{I}_{sd} = \frac{β}{2} {( {V}_{sg} + {V}_{T} )}^{2} \\ = \frac{β}{2} {( {V}_{DD} - \frac{{C}_{OLED}}{{C}_{s} + {C}_{OLED}} {V}_{data} - {V}_{OLED}^{′} )}^{2}\end{matrix}$$

### Therefore, a current not dependent on the threshold voltage of the driver device 22 flows.

Here, COLED denotes a capacitance of the light emitting device 24, Cs a capacitance of the capacitor 23, Isd a source-drain current of the driver device 22, Vsg a source-drain voltage of the driver device 22, and V′OLED a voltage drop of the light emitting device 24 when current Isd flows and thus light is being emitted.

As such, according to the present embodiment, a threshold voltage detection reference voltage is inserted into a signal voltage sent to each pixel supplied to the signal line 15, so it is possible to set the threshold voltage at the drain electrode of the driver device 22 with the switching device 21 being in a conducting state.

The invention has been described in detail with particular reference to certain preferred embodiments thereof, but it will be understood that variations and modifications can be effected within the spirit and scope of the invention.

### PARTS LIST

1 pixel circuit
2 line drive circuit
3 line drive circuit
4 supplying circuit
5 supplying circuit
6 data writing controller
11 switching device
12 driver device
13 capacitor
14 light emitting device
15 signal line
16 scanning line
17 source line
18 source line
21 switching device
22 driver device
23 capacitor
24 light emitting device
30 current value controller
101 switching device
102 driver device
103 capacitor
104 light emitting device
105 signal line
106 scanning line
107 source line
108 source line

1. A display including a plurality of pixels in matrix, wherein each pixel comprising:
first and second power source lines;
a switching device for controlling writing of a signal voltage supplied via a signal line;
a capacitor for storing the signal voltage supplied via the switching device;
an n-type driver device having a gate electrode and first and second electrodes for providing current corresponding to the signal voltage stored by the capacitor;
a light emitting device having an anode and a cathode for emitting light in response to the current wherein the driver device and the light emitting device are arranged in series between the first and second power source lines such that the first electrode of the driver device is connected between the light emitting device and the second electrode of the driver device and the cathode of the light emitting device is connected between the anode of the light emitting device and the driver device and the one side of the capacitor is connected to the gate electrode of the driver device and other side of the capacitor is connected between the first electrode of the driver device and the light emitting device;
first means for causing light emission during a first portion of the operating time; and
second means for detecting and storing a voltage related to the threshold voltage of the driving device during a second portion of the operating time.

2. The display according to claim 1 where the second means causes the switching device to be in a conducting state during detection of the drive threshold voltage.

3. The display according to claim 1 where the second means causes the light emitting device to be in a non-conducting state during detection of the drive threshold voltage.

4. The display according to claim 1, wherein the first means supplies a first voltage which is positive between the first and second power source lines for causing light emission and the second means supplies a second voltage between the first and second power supply lines for detecting the voltage related to the threshold voltage of the driving device where the second voltage is lower than the first voltage.

5. A display including a plurality of pixels in matrix, wherein each pixel comprising:
first and second power source lines;
a switching device for controlling writing of a signal voltage supplied via a signal line;
a capacitor for storing the signal voltage supplied via the switching device;
a p-type driver device having a gate electrode and first and second electrodes for providing current corresponding to the signal voltage stored by the capacitor;
a light emitting device having an anode and a cathode for emitting light in response to the current wherein the driver device and the light emitting device are arranged in series between the first and second power source lines such that the first electrode of the driver device is connected between the light emitting device and the second electrode of the driver device and the anode of the light emitting device is connected between the cathode of the light emitting device and the driver device and the one side of the capacitor is connected to the gate electrode of the driver device and other side of the capacitor is connected between the first electrode of the driver device and the light emitting device;
first means for causing light emission during a first portion of the operating time; and
second means for detecting and storing a voltage related to the threshold voltage of the driving device during a second portion of the operating time.

6. The display according to claim 5 where the second means causes the switching device to be in a conducting state during detection of the drive threshold voltage.

7. The display according to claim 5 where the second means causes the light emitting device to be in a non-conducting state during detection of the drive threshold voltage.

8. The display according to claim 5, wherein the first means supplies a first voltage which is negative between the first and second power source lines for causing light emission and the second means supplies a second voltage between the first and second power source lines for detecting the voltage related to the threshold voltage of the driving device where the second voltage is higher than the first voltage.
